(19) United States
(12) Patent Application Publication
(10) Pub. No.: US 2023/0003992 A1
(43) Pub. Date: Jan. 5, 2023

(54) SCREEN MAGNIFIER

(71) Applicant: XIAOWEI LIN, RUIAN (CN)

(72) Inventor: XIAOWEI LIN, RUIAN (CN)

(21) Appl. No.: 17/562,041

(22) Filed: Dec. 27, 2021

(30) Foreign Application Priority Data
Jul. 1, 2021 (CN) 202130413311.1

(51) Int. Cl. G02B 25/00; G02B 27/02

(52) U.S. Cl. CPC G02B 25/002; G02B 27/027; G02B 27/028

(57) ABSTRACT

A screen magnifier includes a magnifier body and a mounting seat. The magnifier body includes a magnifying glass. A rotating shaft is disposed on the magnifier body. The rotating shaft is disposed perpendicular to a glass surface of the magnifying glass. Mounting holes are on the mounting seat. The rotating shaft is movably connected with the mounting holes. The mounting holes extend along a horizontal direction. The rotating shaft is disposed in the mounting holes. The magnifier body rotated around an axis of the rotating shaft, and the magnifier body is switched between a horizontal position and a vertical position by rotating.

### TECHNICAL FIELD

The present disclosure relates to a field of screen magnifying technology, and in particular to a screen magnifier.

### BACKGROUND

With changes in people's living habits, more and more people are accustomed to using electronic display devices, such as mobile phones, tablet computers, and tutoring machines. Although electronic display device manufacturers have produced different sizes and models of electronic devices to meet people's different preferences, however, middle-aged and elderly people with presbyopia and short-sighted people find it difficult to see a display screen clearly because of small fonts or small sceneries on the display screen when using such electronic devices. Therefore, a convenient device, such as a mobile phone screen magnifier is required to magnify the display screen.

Types and styles of screen magnifiers are becoming more and more diverse. Among them, one type of a magnifier body of a screen magnifier is able to be placed horizontally or vertically to meet needs of a horizontal arranged or a vertical arranged display screen of an electronic device (such as a mobile phone, a tablet, etc.). A setting of the magnifier body is generally realized by connecting structures such as connecting rods or pendulum rods.

### SUMMARY

In view of technical problems in the prior art, a technical problem solved by the present disclosure is to provide a screen magnifier. The screen magnifier is designed with a structure for the magnifying glass to switch between placing horizontally or vertically to meet needs of a horizontal arranged or a vertical arranged display screen of an electronic device (such as a mobile phone, a tablet, etc.). The magnifying glass has a reasonable structure to realize the horizontal and vertical switching, and is convenient to use.

To achieve the above object, the present disclosure provides a screen magnifier. The screen magnifier comprises a magnifier body and a mounting seat. The magnifier body comprises a magnifying glass. A rotating shaft is disposed on the magnifier body. The rotating shaft is disposed perpendicular to a glass surface of the magnifying glass. Mounting holes are on the mounting seat; the rotating shaft is movably connected with the mounting holes. The mounting holes extend along a horizontal direction. The rotating shaft is disposed in the mounting holes.

The magnifier body is rotated around an axis of the rotating shaft to switch between a horizontal position and a vertical position of the magnifier body. In addition, the rotating shaft is movable in the mounting holes of the mounting seat to change a position of the axis of the rotating shaft. The rotating shaft and the mounting seat cooperate with each other to realize switching between the horizontal position and the vertical position of the magnifier body. The magnifying glass is movable to face a display screen of an electronic device after the switching.

Furthermore, the magnifier body comprises a frame. The magnifying glass is connected with the frame. By configuring the frame, a structure of the magnifying glass is stable, and mounting of the rotating shaft is convenient.

Furthermore, the magnifying glass is rectangular or quasi-rectangular. The rotating shaft is disposed on a corner of the frame or the rotating shaft is disposed on a corner of the magnifying glass, which makes a structure layout reasonable, makes the magnifying glass convenient to rotate. Thus, the magnifying glass is switched between the horizontal position and the vertical position with respect to one side of the mounting seat.

Furthermore, a magnifying glass support portion is disposed on the mounting seat. After the magnifier body is rotated horizontally and vertically, the magnifier body is then supported by the magnifying glass support portion, which makes a position of the magnifier body on the mounting seat stable.

Furthermore, the mounting holes are horizontal holes. The mounting holes are horizontal holes, so when the rotating shaft is mounted in the mounting holes, the rotating shaft is able to move horizontally left and right, which is convenient to use, and makes support effect of the mounting seat on the magnifier body good.

Furthermore, the mounting seat comprises a first mounting portion and a second mounting portion. A receiving groove is defined between the first mounting portion and the second mounting portion. The mounting holes comprise a first mounting hole defined on the first mounting portion and a second mounting hole defined on the second mounting portion. The rotating shaft comprises shaft heads disposed on two sides of the magnifying glass. The shaft heads are respectively disposed in the first mounting hole defined on the first mounting portion and the second mounting hole defined on the second mounting portion. The rotating shaft is supported by the mounting holes on front and rear sides and is movable along the mounting holes, making the rotating shaft running stably, and making rotation of the magnifier body stable.

Furthermore, a bottom portion of the receiving groove is configured as the magnifying glass support portion. An inner wall of the first mounting portion and an inner wall of the second mounting portion are provided with first positioning holes or first positioning protrusions. The magnifying glass or the frame comprises second positioning protrusions matched with the first positioning holes or second positioning holes matched with the first positioning protrusions. A rotating supporting block is disposed on the magnifying glass or the frame. The rotating shaft is disposed on the rotating supporting block. The rotating supporting block has a circumferential surface. The circumferential surface abuts against the bottom portion of the receiving groove. After the magnifier body s is rotated and is switched between the horizontal position and the vertical position, the magnifier body is received in the receiving groove stably. Further, the position the magnifying glass is relatively fixed by positioning structures. Moreover, the rotating supporting block rotates against the bottom portion of the receiving groove to assist rotation of the magnifier body around the rotating shaft and makes the rotation stable.

Furthermore, the screen magnifier further comprises a housing. The housing comprises a drawing chamber. The drawing chamber is configured to receive the magnifier body. The mounting seat is detachably inserted into an entrance of the drawing chamber and a position of the mounting seat is limited by the entrance of the drawing chamber. Support blocks are disposed on the housing. Each of the support blocks is provided with an opening groove. The support blocks are disposed on a left side and a right side of the entrance of the drawing chamber. Rotating rods are disposed on a left end and a right end of the mounting seat. Each of the opening grooves comprises a positioning position configured to match with a corresponding rotating rod. A storage turning bracket is disposed on the housing. The magnifier body and the mounting seat form a switching device that is able to switch horizontally and vertically. By arrangement of the housing, the magnifier body is received in, drawn out, and inserted into the drawing chamber, which is convenient for storage. When in use, the switching device is withdrawn from the drawing chamber first and then placed on the support blocks. Then the switching device is rotated at the entrance. The storage turning bracket is configured to hold the electronic device.

Furthermore, supporting rotating feet are disposed on a left side and a right side of the housing. The supporting rotating feet are disposed at a front portion of the housing. The opening grooves of the support blocks are disposed forward. The placement positions are provided with arc-shaped notches. The rotating rods are disposed coaxially. The rotating rods are disposed below the magnifying glass. By adjusting the supporting rotating feet, an inclination angle of the housing is adjusted, which is convenient for viewing from different angles.

Furthermore, the storage turning bracket comprises turning shafts, a support plate, and support hooks. The turning shafts are disposed in connecting holes of the housing. The turning shafts are connected with the support plate. The support hooks are disposed on the support plate. A structure of the storage turning bracket is reasonable, and the storage turning bracket hold the electronic device stably.

In the screen magnifier of the present disclosure, the magnifier body rotated around the axis of the rotating shaft, and the horizontal position and the vertical position of the magnifier body is switched by rotating, so as to adapt to horizontal or vertical viewing of the display screen of the electronic device. In addition, the rotating shaft moves in the mounting holes of the mounting seat. The position of the axis of the rotating shaft is changed in the mounting holes, which cooperates with the mounting holes to realize the switching between the horizontal position and the vertical position of the magnifier body, while ensuring that the magnifier body is moved to face the display screen of the electronic device after the switching. The switching device is reasonable in structure and is convenient to use.

### BRIEF DESCRIPTION OF DRAWINGS

The relevant details and working principles of the embodiments of the present disclosure will be described below in conjunction with the accompanying drawings.

FIG. 1 is a schematic diagram showing structures of a magnifier body and a mounting seat of the present disclosure.

FIG. 2 is an exploded schematic diagram thereof.

FIG. 3 is another exploded schematic diagram thereof.

FIG. 4 is a schematic diagram showing structures of the magnifier body and the mounting seat of the present disclosure where the magnifying glass is switched from a horizontal position to a vertical position.

FIG. 5 is a schematic diagram of the screen magnifier of the present disclosure where the magnifier body is received in a housing.

FIG. 6 is another schematic diagram thereof.

FIG. 7 is a schematic diagram of the housing shown in an open state.

FIG. 8 is an enlarged view of the area A shown in FIG. 7.

FIG. 9 is an exploded schematic diagram of the housing.

FIG. 10 is another exploded schematic diagram of the housing.

FIG. 11 is a perspective schematic diagram of the screen magnifier of the present disclosure where the magnifier body is in a horizontal position.

FIG. 12 is a perspective schematic diagram of the screen magnifier of the present disclosure where the magnifying glass is in a vertical position.

FIG. 13 is another perspective schematic diagram of the screen magnifier shown in FIG. 12.

### DETAILED DESCRIPTION

The following will clearly and completely describe the technical solutions in the embodiments of the present disclosure in conjunction with the accompanying drawings in the embodiments of the present disclosure. Obviously, the described embodiments are only parts of the embodiments of the present disclosure, not all of the embodiments. Based on the embodiments of the present disclosure, all other embodiments obtained by those of ordinary skill in the art without creative work, should fall within the protection scope of the present disclosure.

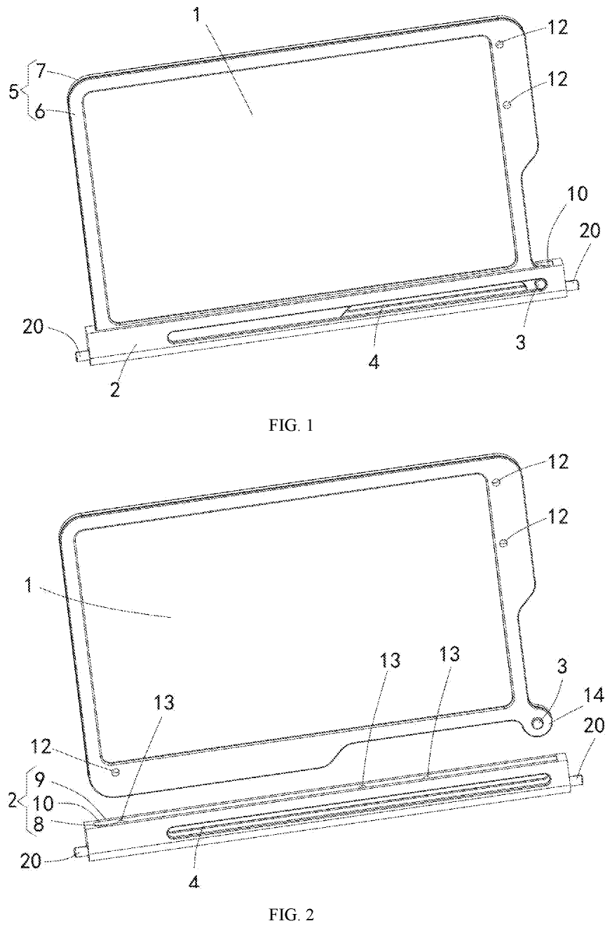

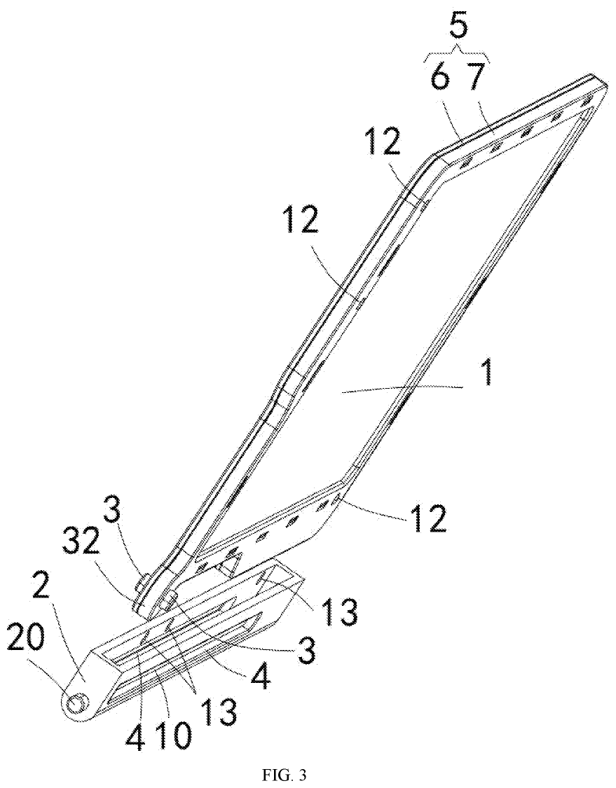

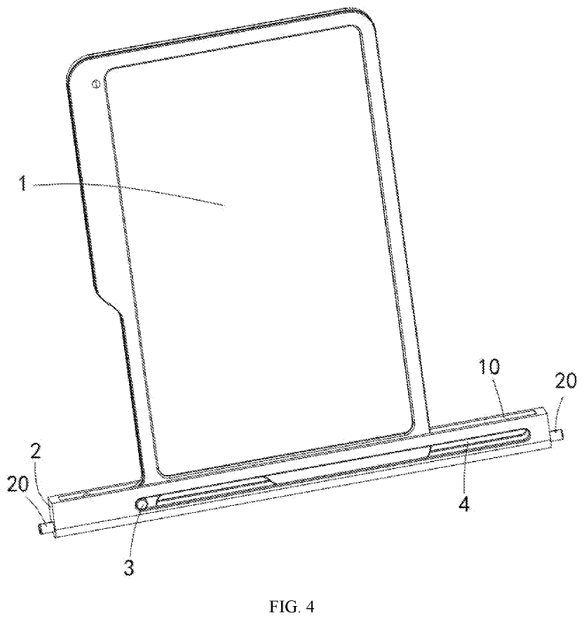

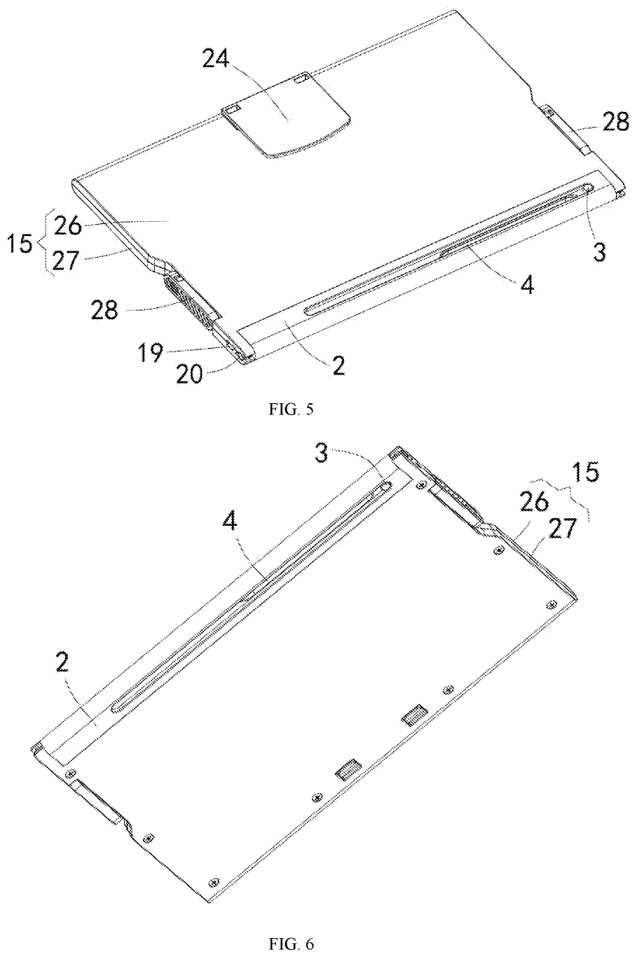

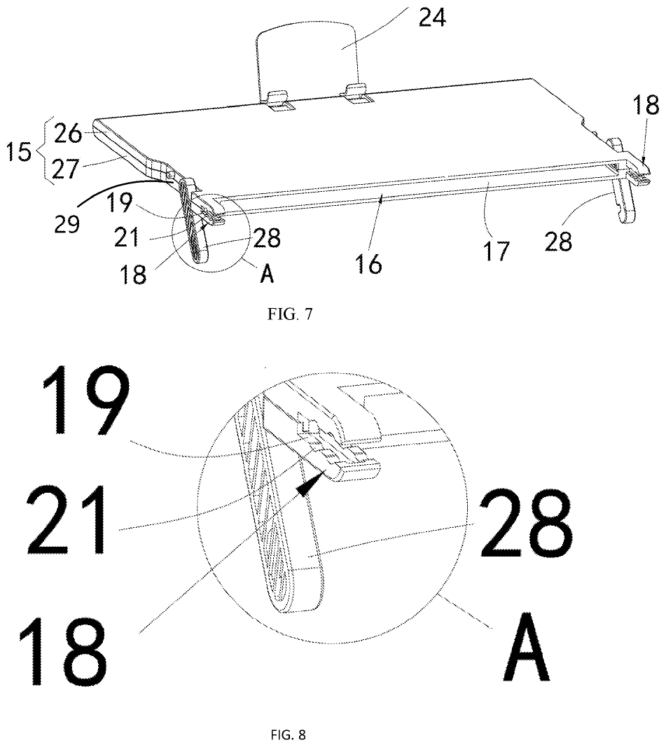

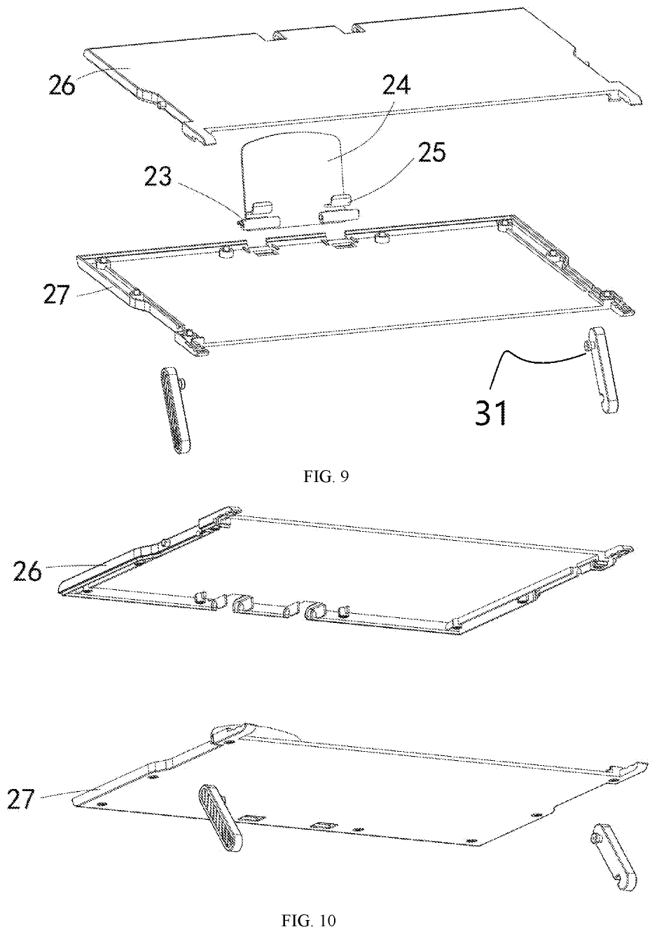

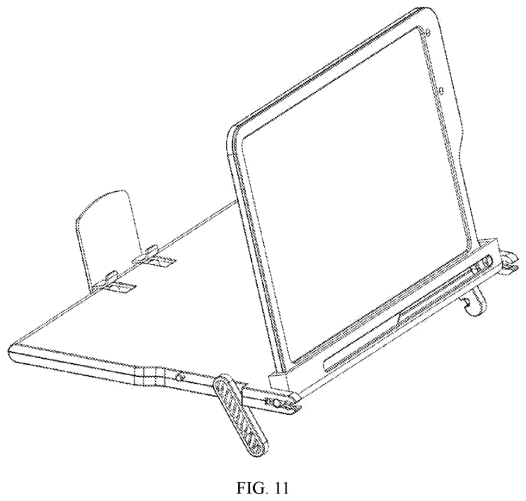

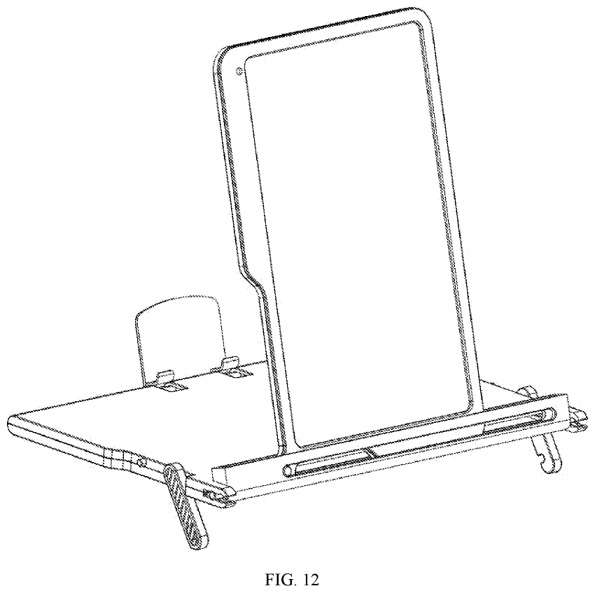

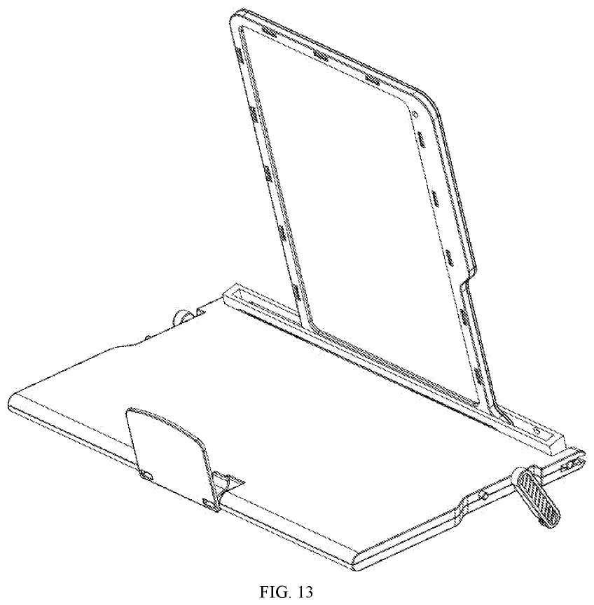

As shown in FIGS. 1-13, the present disclosure provides a screen magnifier. In one embodiment, the screen magnifier comprises a magnifier body and a mounting seat 2. The magnifier body comprises a magnifying glass 1. A rotating shaft 3 is disposed on the magnifier body. The rotating shaft 3 is disposed perpendicular to a glass surface of the magnifying glass. The magnifier body is rotated around an axis of the rotating shaft to switch between a horizontal position and a vertical position of the magnifier body. The rotating shaft 3 may be relatively fixedly connected with the magnifier body. That is, as shown in the drawings, the rotating shaft 3 and the magnifier body are rotated synchronously, the structure of which is reasonable, and the assembly is convenient. Of course, the rotating shaft 3 and the magnifier body can also be rotated asynchronously, and the magnifier body is relatively sleeved on the rotating shaft 3. By rotating back and forth, the magnifying glass 1 is switched between the horizontal position and the vertical position.

In addition, mounting holes 4 are on the mounting seat. The mounting holes 4 extend along a horizontal direction. The rotating shaft 3 is movably connected with the mounting holes 4. The rotating shaft 3 is disposed in the mounting holes 4. The rotating shaft 3 is movable in the mounting holes 4 of the mounting seat 2 to change a position of the rotating shaft 3.

For example, as shown in the drawings, when the magnifier body is switched from the horizontal position to the vertical position, the rotating shaft 3 is moved to the left along the mounting holes 4, and the magnifier body rotates clockwise to switch to the vertical position. Similarly, when the magnifier body is switched from the vertical position to the horizontal position, the rotating shaft 3 moves to the right along the mounting holes 4, and the magnifier body rotates counterclockwise to switch to the horizontal position. The magnifier body is located at a middle portion with respect to the mounting seat no matter it is in the vertical position or the horizontal position, so it is always directly facing a display screen of an electronic device.

In the screen magnifier of the present disclosure, the magnifier body rotated around the axis of the rotating shaft 3, and the horizontal position and the vertical position of the magnifier body is switched by rotating, so as to adapt to horizontal or vertical viewing of the display screen of the electronic device. In addition, the rotating shaft 3 moves in the mounting holes 4 of the mounting seat 2. The position of the axis of the rotating shaft 3 is changed in the mounting holes 4, which cooperates with the mounting holes 4 to realize the switching between the horizontal position and the vertical position of the magnifier body, while ensuring that the magnifying glass 1 is moved to face the display screen of the electronic device after the switching. The screen magnifier is reasonable in structure and is convenient to use.

On the basis of the above embodiment, the following embodiments or further descriptions are made.

In one embodiment, the magnifier body further comprises a frame 5. The magnifying glass 1 is connected with the frame 5. The rotating shaft 3 is disposed on the frame 5. By configuring the frame 5, a structure of the magnifying glass 1 is stable, and mounting of the rotating shaft 3 is convenient. The frame 5 is a full frame structure, a half frame structure, or a partial frame structure, which is not limited thereto. Of course, it is not necessary to configure the frame 5, and the rotating shaft 3 may be directly disposed on the magnifying glass 1, or the rotating shaft 3 may be disposed on a mounting block disposed on the magnifying glass 1. In the embodiment, as shown in the drawings, the frame 5 is a full frame, and the frame 5 comprises a front frame 6 and a rear frame 7. The front frame 6 and the rear frame 7 are assembled together by fasteners or buckles. The front frame 6 and the rear frame 7 clamp the magnifying glass 1 to fix the magnifying glass 1.

Furthermore, the magnifying glass 1 is rectangular or quasi-rectangular. The rotating shaft 3 is disposed on a corner of the frame 5 or the rotating shaft is disposed on a corner of the magnifying glass 1, which makes a structure layout reasonable, makes the magnifying glass 1 convenient to rotate. Thus, the magnifying glass 1 is switched between the horizontal position and the vertical position with respect to one side of the mounting seat 2 to match with the display screen of the electronic device.

Furthermore, a magnifying glass support portion is disposed on the mounting seat 2. After the magnifier body is rotated horizontally and vertically, the magnifier body is then supported by the magnifying glass support portion, which makes a position of the magnifier body on the mounting seat 2 stable.

There are many ways to design the magnifying glass support portion, such as using a support block or a support strip to hold the magnifying glass 1 (or the magnifying glass 1 and the frame 5). In the embodiment, the bottom portion 11 of the receiving groove 10 is configured as the magnifying glass support portion, which will be explained in detail below.

In one embodiment, the mounting holes 4 are horizontal holes, so the rotating shaft 3 is able to move horizontally left and right in the mounting holes 4. The magnifying glass 1 is rectangular or quasi-rectangular and the mounting holes 4 are horizontal holes, so when the rotating shaft 3 is mounted in the mounting holes 4, the rotating shaft 3 is able to move horizontally left and right, which is convenient to use, and makes support effect of the mounting seat 2 on the magnifier body good. When in use, the magnifier body is connected with the mounting seat 2 and is supported by the mounting seat 2. The magnifying glass 1 is rectangular or quasi-rectangular, which can well match the current display screen of the electronic device.

Furthermore, the mounting seat 2 comprises a first mounting portion 8 and a second mounting portion 9. A receiving groove 10 is defined between the first mounting portion 8 and the second mounting portion 9. The mounting holes 4 comprises a first mounting hole defined on the first mounting portion 8 and a second mounting hole defined on the second mounting portion 9. The rotating shaft 3 comprises shaft heads disposed on two sides of the magnifier body. The shaft heads are respectively disposed in the first mounting hole defined on the first mounting portion 8 and the second mounting hole defined on the second mounting portion 9. The rotating shaft 3 is supported by the mounting holes 4 on front and rear sides and is movable along the mounting holes 4, making the rotating shaft 3 running stably, and making the magnifier body rotating stably. As shown in the drawings, the first mounting portion 8 is a first plate, the second mounting portion 9 is a second plate, and the mounting holes 4 are specifically adopted as horizontal strip-shaped holes. In addition, a length of the mounting holes 4 is optimized so that when the rotating shaft 3 is leaning against left ends of the mounting holes, the magnifying glass 1 is just at the middle position after being turned to the right, and when the rotating shaft 3 abuts against right ends of the mounting holes, the magnifying glass 1 is at the middle position after being rotated clockwise. Thus, the magnifying glass 1 is more convenient to use. A moving range of the rotating shaft 3 is limited by the mounting holes, so that the magnifying glass 1 is always in the middle position regardless of whether the magnifier body is in the horizontal position or the vertical position.

Furthermore, a bottom portion of the receiving groove 10 is configured as the magnifying glass support portion 11. An inner wall of the first mounting portion 8 and an inner wall of the second mounting portion 9 are provided with first positioning holes 12 or first positioning protrusions. The magnifying glass 1 or the frame 5 comprises second positioning protrusions 13 matched with the first positioning holes 12 or second positioning holes matched with the first positioning protrusions. Therefore, the magnifying glass 1 or the frame 5 is positioned and is fixedly disposed in the receiving groove 10. The magnifier body is stably placed in the receiving groove 10 after rotating and switching positions, and the magnifier body is further relatively fixed by the positioning structures

Furthermore, a rotating supporting block 14 is provided. The rotating supporting block is disposed on the magnifying glass 1 or the frame 5. The rotating shaft 3 is disposed on the rotating supporting block 14. That is, the rotating shaft 3 is connected with the magnifying glass 1 or the frame 5 through the rotating supporting block 14. The rotating supporting block 14 has a circumferential surface 32. The circumferential surface 32 abuts against the bottom portion 11 of the receiving groove 10. The rotating supporting block 14 rotates against the bottom portion 11 of the receiving groove 10 to assist rotation of the magnifier body around the rotating shaft 3 and makes the rotation stable.

In one embodiment, the screen magnifier further comprises a housing 15. The mounting seat 2 is connected with the housing 15. The housing 15 has many styles and types, which is not limited thereto.

In the embodiment, the housing 15 comprises a drawing chamber 16. The drawing chamber 16 has an entrance 17 for insertion and extraction of the magnifier body. The drawing chamber 16 is configured to receive the magnifying glass 1 and the frame 5. The mounting seat 2 is detachably inserted into the entrance 17 of the drawing chamber and a position of the mounting seat 2 is limited by the entrance 17 of the drawing chamber 16. Support blocks 18 are disposed on the housing 15. Each of the support blocks 18 is provided with an opening groove 19. The support blocks 18 are disposed on a left side and a right side of the entrance 17 of the drawing chamber 16. Rotating rods 20 are disposed on a left end and a right end of the mounting seat 2. Each of the opening grooves 19 comprises a positioning position 21 configured to match with a corresponding rotating rod 20.

When the magnifier body is inserted into the drawing chamber 16, the rotating rods 20 at two ends of the mounting seat 2 are accommodated in the opening grooves 19, and the mounting seat 2 is blocked and limited by the entrance 17 of the drawing chamber 16. After the magnifier body is drawn out from the drawing chamber 16, it can be reversed. That is, the rotating shafts 20 at two ends of the mounting seat 2 are first placed in the opening grooves 19 on the support blocks 18, and then the mounting seat 2 is rotated and leans against the entrance 17 of the drawing chamber 16, and the entrance 17 of the drawing chamber 16 is cooperated with the mounting seat 2, so that the magnifier body disposed on the mounting seat 2 is inclined to a certain angle.

Furthermore, a storage turning bracket 22 is disposed on the housing 15. The storage turning bracket is configured to hold the electronic device, such as a mobile phone. The magnifier body and the mounting seat 2 form a switching device that is able to switch horizontally and vertically. By arrangement of the housing 15, the switching device can be received in, drawn out, and inserted into the drawing chamber 16, which is convenient to storage. When in use, the switching device is withdrawn from the drawing chamber first and then rotated and placed on the support blocks. Then the switching device is leaned on the entrance to use.

The magnifying glass 1 is disposed in the middle position after being switched horizontally and vertically to correspond to the storage turning bracket 22. The storage turning bracket 22 is arranged in a middle position of a rear side of the housing 15, and the entrance 17 of the drawing chamber 16 is located on a front side. The rotating rods 20 are arranged on a same axis, that is, the rotating rods 20 are coaxially disposed. The rotating rods 20 are disposed below the magnifier body, making the structure reasonable.

Furthermore, the storage turning bracket 22 adopts mature technology. In the embodiment, the storage turning bracket 22 comprises turning shafts 23, a support plate 24, and support hooks 25. The turning shafts 23 are disposed in connecting holes of the housing 15. The turning shafts 23 are connected with the support plate 24. The support hooks 25 are disposed on the support plate 24. A structure of the storage turning bracket 22 is reasonable, and the storage turning bracket 22 hold the electronic device stably.

The housing 15 comprises an upper housing 26 and a lower housing 27. The upper housing 26 and the lower housing 27 clamp the turning shafts 23. The connecting holes are defined by the upper housing 26 and the lower housing 27. That is, the upper housing 26 and the lower housing 27 are provided with semicircular holes. The upper housing 26 and lower housing cooperate to form the connecting holes for arrangement of the turning shafts 23. In addition, limit structures can be set between the housing 15 and the turning shafts 23, such as limit blocks and limit ports.

Furthermore, supporting rotating feet 28 are disposed on a left side and a right side of the housing 15. The supporting rotating feet 28 are disposed at a front portion of the housing 15. The supporting rotating feet 28 are rotattable. By adjusting the supporting rotating feet 28, an inclination angle of the housing 15 is adjusted, which is convenient for viewing from different angles.

The supporting rotating feet 28 are rotated by the connecting blocks 31 disposed on the supporting rotating feet 28. The connecting blocks 31 are clamped by the upper housing 26 and the lower housing 27. Of course, the supporting rotating feet 28 can also be connected to the housing by other structures such as shafts or screws. In addition, the housing 15 (such as limiting steps 30 on both sides of the housing 15) limit a rotation angle of the supporting feet 28. The supporting rotating feet 28 are disposed in recesses 29 on two sides of the housing 15 and the limiting steps 30 are disposed in front of the recesses 29.

Furthermore, the opening grooves 19 of the support blocks 18 are disposed forward (the direction of the he opening grooves 19 is same as that of the entrance 17). The positioning positions 21 are provided with arc-shaped notches. The arc-shaped notches are on an lower wall and an upper wall of the opening grooves 19, and the rotating rods 20 of the mounting seat 2 are limited by the arc-shaped notches, so that the mounting seat 2 is rotated and leaned against the upper portion of the housing 15 (the entrance 17 of the drawing chamber 16). Therefore, the position of the magnifier body is further limited.

The above are optional embodiments of the present disclosure, and it should be pointed out that the protection scope of the present disclosure is not limited thereto. For those skilled in the art, without departing from the equivalent inventive concept of the technical scope disclosed by the present disclosure, several improvements, modifications, or equivalent replacements can be made, which are also regarded as the protection scope of the present disclosure.

What is claimed is:

1. A screen magnifier, comprising a magnifier body and a mounting seat; wherein a rotating shaft is disposed on the magnifier body; the magnifier body comprises a magnifying glass; the rotating shaft is disposed perpendicular to a glass surface of the magnifying glass; mounting holes are on the mounting seat; the rotating shaft is movably connected with the mounting holes; the mounting holes extend along a horizontal direction; the rotating shaft is disposed in the mounting holes.

2. The screen magnifier according to claim 1, wherein the magnifier body comprises a frame; the magnifying glass is connected with the frame.

3. The screen magnifier according to claim 2, wherein the magnifying glass is rectangular or quasi-rectangular; the rotating shaft is disposed on a corner of the frame or the rotating shaft is disposed on a corner of the magnifying glass.

4. The screen magnifier according to claim 1, wherein a magnifying glass support portion is disposed on the mounting seat.

5. The screen magnifier according to claim 1, wherein the mounting holes are horizontal holes.

6. The screen magnifier according to claim 4, wherein the mounting seat comprises a first mounting portion and a second mounting portion; a receiving groove is defined between the first mounting portion and the second mounting portion; the mounting holes comprise a first mounting hole defined on the first mounting portion and a second mounting hole defined on the second mounting portion; the rotating shaft comprises shaft heads disposed on two sides of the magnifier body; the shaft heads are respectively disposed in the first mounting hole defined on the first mounting portion and the second mounting hole defined on the second mounting portion.

7. The screen magnifier according to claim 6, wherein a bottom portion of the receiving groove is configured as the magnifying glass support portion; an inner wall of the first mounting portion and an inner wall of the second mounting portion are provided with first positioning holes or first positioning protrusions; the magnifier body comprises second positioning protrusions matched with the first positioning holes or second positioning holes matched with the first positioning protrusions; a rotating supporting block is disposed on the magnifier body; the rotating shaft is disposed on the rotating supporting block; the rotating supporting block has a circumferential surface; the circumferential surface abuts against the bottom portion of the receiving groove.

8. The screen magnifier according to claim 1, wherein the screen magnifier further comprises a housing, the housing comprises a drawing chamber, the drawing chamber is configured to receive the magnifier body; the mounting seat is detachably inserted into an entrance of the drawing chamber and a position of the mounting seat is limited by the entrance of the drawing chamber; support blocks are disposed on the housing; each of the support blocks is provided with an opening groove; the support blocks are disposed on a left side and a right side of the entrance of the drawing chamber; rotating rods are disposed on a left end and a right end of the mounting seat; each of the opening grooves comprises a positioning position configured to match with a corresponding rotating rod; a storage turning bracket is disposed on the housing.

9. The screen magnifier according to claim 8, wherein supporting rotating feet are disposed on a left side and a right side of the housing; the supporting rotating feet are disposed at a front portion of the housing; the opening grooves of the support blocks are disposed forward; the placement positions are provided with arc-shaped notches; the rotating rods are disposed coaxially; the rotating rods are disposed below the magnifying glass.

10. The screen magnifier according to claim 8, wherein the storage turning bracket comprises turning shafts, a support plate, and support hooks; the turning shafts are disposed in connecting holes of the housing; the turning shafts are connected with the support plate; the support hooks are disposed on the support plate.
